(19) United States
(12) Patent Application Publication
(10) Pub. No.: US 2013/0229072 A1
(43) Pub. Date: Sep. 5, 2013

(54) Cooling Structure for Cooling Electric Motor for Vehicle

(71) Applicant: Yoshimoto Matsuda, Kobe-shi (JP)

(72) Inventor: Yoshimoto Matsuda, Kobe-shi (JP)

(73) Assignee: KAWASAKI JUKOGYO KABUSHIKI KAISHA, Kobe-shi, Hyogo (JP)

(21) Appl. No.: 13/883,980

(22) PCT Filed: Nov. 12, 2010
(86) PCT No.: PCT/JP2010/006648

§ 371 Date: May 20, 2013

(51) Int. Cl. H02K 9/19; H02K 7/116

(52) U.S. Cl. CPC H02K 9/19; H02K 7/116
USPC 310/53; 310/54

(57) ABSTRACT

In an electric motor for a vehicle (21) which includes a stator (21) fixed to an outer case member (41) side, and a rotor (22) which rotates relative to the stator (21), an ejection hole (45b) for ejecting a coolant is provided in a disc-like member (45) which faces an end face in a rotary shaft direction of the rotor (22), non-conducting oil for cooling is fed from an oil pump (46) to a fluid path (41c) communicating with the ejection hole (45b), and the oil ejected from the ejection hole (45b) is sprayed onto at least a coil end (21a) of the stator (21). With this configuration, it is possible to provide a cooling structure for cooling a motor which, even though having a simple structure, can stably and efficiently cool the motor and rarely allows an increase in rotation resistance.

### TECHNICAL FIELD

The present invention relates to a cooling structure for cooling an electric motor in an electric vehicle such as an electric car, an electric motorcycle, and a hybrid car.

### BACKGROUND ART

In recent years, with a growing interest in the environment and from the prospect of depletion of oil resources in the future, it is more highly demanded than before to reduce fuel consumption in an automobile, an electric motorcycle, etc. On the one hand, there has been fast progress in the research and development of secondary cells represented by a lithium ion cell, and attempts to use electricity as a power source for driving the electric car or the hybrid car become highly popular.

Generally an electric motor has quite high energy efficiency as compared with an internal-combustion engine, but it generates heat during its operation. A leading cause of the heat is generation of heat (so-called copper loss) from a coil attributable to resistance of an electrical current flowing through windings. This increases temperature of the coil, resulting in an increase in the electrical resistance of the windings and a decrease in efficiency. The increased electrical resistance leads to generation of heat again, falling in a vicious cycle of the generation of heat, the rise in temperature, and the increase in electrical resistance. This becomes an obstacle to improving the output of the motor.

For this reason, from the past, various cooling structures have been proposed to effectively cool the electric motor in an electric vehicle. For example, Patent Document 1 discloses a technology which water-cools a case member of a motor and directly cools an exothermic portion of the motor using cooling oil, such as ATF, stored in the case member. According to this technology, a coil wound around a core part of a stator is produced by resin molding, and an oil path of the cooling oil is provided near a coil end which easily becomes a high temperature.

A portion of the winding of the coil end is exposed to this oil path, so that it is effectively cooled by the cooling oil. By supplying the cooling oil pumped up by a pump or the like to the oil path from above and squeezing out the cooling oil discharged from an outlet disposed at a lower end of the oil path by shaping the outlet like an orifice, the whole oil path becomes filled with the cooling oil and the winding of the coil is immersed.

On the one hand, Patent Document 2 discloses a cooling structure in which an oil path of cooling oil is provide between a coil end of a stator and a coil end cover in an electric motor in order to directly cool the coil end using a coolant like in the above-mentioned technology, and the coolant is allowed to leak from the oil path so as to fill up a minute gap between the coil end cover and a case member of a motor. With this configuration, thermal resistance between the coil end cover and the case member of the motor decreases, and the cooling efficiency increases.

In addition, for example, Patent Document 3 discloses a motor configured such that cooling oil, such as ATF and gear oil, is sprayed onto a coil end of a stator so that the coil end can be cooled. In this configuration, the cooling oil is sprayed onto the coil end of the stator in a manner that the cooling oil is first introduced into a hollow portion formed near an end plate of a rotor via an oil path in a shaft, and then the cooling oil is ejected from an ejection hole communicating with the hollow portion by centrifugal force generated by rotation of the rotor.

Furthermore, arrangement of the ejection hole is set in consideration of the fact that the orbit or ejecting force of the ejected cooling oil changes according to the centrifugal force which changes according to a rotation speed of the rotor so that the cooling oil may be sprayed onto the coil end of the stator in a state of being stabilized as uniformly as possible.

### PRIOR ART DOCUMENTS

### Patent Documents

Patent Document 1: Japanese Patent Application Laid-Open Publication No. 2006-197772

Patent Document 2: Japanese Patent Application Laid-Open Publication No. 2009-118667

Patent Document 3: Japanese Patent Application Laid-Open Publication No. 2009-273285

### SUMMARY OF THE INVENTION

### Problems to be Solved by the Invention

However, when the oil path is provided in the resin-molded body with which the coil of the core portion of the stator is molded together or when the oil path is provided between the coil end and the coil end cover as described in the above-described conventional examples (Patent Documents 1 and 2), a production man hour or the number of parts is increased, resulting in a cost hike.

When the winding becomes a high temperature in the state in which it is immersed in the cooling oil in the oil path, there is a problem that deterioration of the covering occurs and mechanical strength and dielectric strength of the covering decrease. In this regard, according to the technology of Patent Document 1, under the condition of a small heat load, control is performed such that an amount of a coolant supplied to the oil path is reduced to prevent the winding from being immersed in the coolant. However, this control causes a further cost hike.

On the other hand, when the cooling oil is sprayed onto the coil end like in the latter conventional example (Patent Document 3), the structure can be comparatively simplified. However, when the coolant is ejected from the rotor rotating at high speed, it is not easy to precisely spray the coolant ejected from it onto the coil end as intended no matter how hard the study is made on the arrangement of the ejection hole. Furthermore, there is a risk that the cooling oil which rebounds after being sprayed onto the coil end is likely to invade a gap between the rotor and the stator, and if this occurs, rotation resistance increases.

Yet furthermore, since an oil sac and/or a feed oil path of the cooling oil are provided in the rotor rotating at high speed and even the ejection hole is provided in the rotor, when taking rotational balance, an oscillation characteristic, etc. of the rotor into consideration, considerable precision in processing and assembly is likely to be highly demanded.

Accordingly, an object of the invention is to provide a motor cooling structure which can cool a motor with stabilized performance and higher efficiency than conventional ones, while having a simple structure, involving no fear of a cost hike, and nearly disallowing an increase in rotation resistance.

### Solutions to the Problems

The present invention is intended to provide a cooling structure for cooling an electric motor, for a vehicle, including a stator fixed to a case member side and a rotor rotating relative to the stator, the cooling structure including an ejection hole of a coolant provided in a member, of the case member, which faces an end surface of the rotor in a rotary shaft direction, and coolant feeding means that feeds a coolant into a fluid path communicating with the ejection hole, in which the coolant ejected from the ejection hole is made to be sprayed onto least a coil end of the stator.

According to the configuration, the ejection hole for a coolant and the fluid path communicating with the ejection hole are provided in the member of the case member side of the electric motor, and the coolant fed by the coolant feeding means through the fluid path is ejected from the ejection hole, and sprayed onto the coil end of the stator. Since an ejection amount of the coolant is dependent on pressure of the coolant, the ejection amount of the coolant can be adjusted by adjusting the pressure when the coolant is fed by the coolant feeding means. Therefore, highly efficient and stable cooling can be achieved because a suitable amount of the coolant can be directly sprayed onto the coil end, even through the structure is simplified.

In addition, it is possible to suppress the coolant sprayed on the coil end from rebounding and invading the gap between the rotor by adjusting the ejection pressure of the coolant so as to fall within a suitable range. Since the sprayed coolant moves down due to the gravity and drops from the lower end of the coil end, the winding of the coil does not remain immersed in the coolant like in the former conventional examples (Patent Documents 1 and 2). For this reason, there is only a little risk of progress in degradation of the covering. From this point of view, it is preferable that a lowest portion of the stator is located at a higher position than a liquid surface even when a storage part of the coolant is provided in a lower portion of the case member of the electric motor, and it is more preferable that a partition plate is formed between the liquid surface and the lowest portion of the stator which is disposed above the storage part.

In regards to an appropriate position of the ejection hole, for example, a plurality of ejection holes may be provided so as to correspond to a plurality of coils of the stator, respectively so that the coolant is sprayed to each of the plurality of coils of the stator from the ejection holes, respectively. With this arrangement, cooling of the coil end is carried out more efficiently. In addition, when a rotary shaft of the rotor extends substantially horizontally, the number of the ejection holes of the coolant that are provided above the rotary shaft of the rotor may be larger than that provided below the rotary shaft of the rotor. With this arrangement, a large amount of oil can be sprayed to an upper portion of the coil end, and the whole can be more efficiently cooled.

In addition, when the stator is arranged to surround an outer circumference side of the rotor and fixed to the case member, if an outer circumference of the core of the stator is made to be in tight contact with the case member made of a metal, the outer circumference side of the coil can be effectively cooled via the case member. Accordingly, in this case, it is preferable that the ejection holes of the coolant be provided on an inner circumference side than the coil end of the stator so that cooling is started from the inner circumference side where heat easily accumulates.

Conversely, when the rotor is arranged to surround an outer circumference side of the stator, it is preferable that a portion which protrudes outward from an end surface of the rotor in the rotary shaft direction be provided near a lower end portion of the coil end of the stator. With this configuration, the coolant which drops from the lower end portion of the coil end hardly reaches the rotor, and it is advantageous in suppressing invasion of the coolant into the gap between the rotor and the stator.

At least a portion of the fluid path communicating with the election hole may be formed between a plurality of members of a case member side which mutually overlap each other, or the ejection holes may be formed in at least one of members of the case member side. For example, in a ease where the ejection hole is formed by cutting processing, an ejection direction of the ejection hole can be set up to exactly aim at the coil end.

The coolant which has used to cool the coil end of the stator may be circulated between a heat exchanger arranged outside the case member of the electric motor, and the heat exchanger may be disposed such that a traveling wind may pass by. With this configuration, the coolant, which has heat-exchanged with the traveling wind and become cold again, directly cools the coil end which is an exothermic portion of the electric motor, thereby acquiring as high cooling effect as possible.

Furthermore, an electric pump that is variable in operation speed may be further provided as coolant feeding means. With this configuration, an amount of the coolant is increased with an increase in the temperature of the electric motor, so that required sufficient cooling can be performed. The temperature of the electric motor may be measured by a sensor or may be estimated, for example, from a motor current value, etc.

On the one hand, when taking a cost into consideration, the coolant feeding means may be equipped with a mechanical pump which is mechanically connected to a traveling motor for a vehicle. With this configuration, since a discharge amount of the coolant increases with an increase in a rotation speed of the motor, as a result, cooling which is adaptively performed according to a temperature state of the electric motor can be carried out.

Furthermore, a gear type driving force transmission mechanism which transmits a torque of the electric motor may be accommodated in the case member of the electric motor to use the coolant for lubrication. When rotation of the electric motor is slowed down by the gear type driving force mechanism device and is then output, a torque load to the electric motor decreases, so that generation of heat can be suppressed.

In addition to the configuration, a fin may be further provided in the end surface of the rotor in the rotary shaft direction of the rotor so that air, which occurs due to the rotation, may be sent outward in the rotary shaft direction. With this configuration, the wind created by rotation of the fin will blow away the coolant which drops from the coil end so that the coolant may also move away from the rotor. Therefore, invasion of the coolant into the gap between the stator can be more certainly prevented.

### Effects of the Invention

According to the cooling structure for cooling the electric motor for a vehicle according to the present invention, by including the means to feed the coolant, the coolant is made to be ejected from the ejection hole to the coil end of the stator at a suitable ejection pressure. Accordingly, although the cooling structure has a simplified structure, a suitable amount of the coolant can be directly sprayed onto the coil end which easily becomes a high temperature and hence the motor can be stably and efficiently cooled. Since a suitable amount of coolant is directly sprayed onto the coil end which easily becomes a high temperature, the motor can be stably and efficiently cooled. Since invasion of the coolant into the gap between the stator and the rotor can be suppressed, there is only a little fear that degradation of covering of the winding of the coil progresses.

### BRIEF DESCRIPTION OF THE DRAWINGS

FIG. 1 is a right side view illustrating main parts, such as a power plant, of an electronic motorcycle according to a first embodiment of the present invention.

FIG. 2 is a front view of the same electronic motorcycle viewed from the front.

FIG. 3 is a developed view illustrating the structure of a power plant of the same electronic motorcycle.

FIG. 4 is an explanatory view illustrating the structure of an ejection hole for cooling oil.

FIG. 5 is an explanatory view illustrating arrangement of main components in the power unit.

FIG. 6 is a view which is equivalent to FIG. 1 and illustrates a second embodiment.

FIG. 7 is a view equivalent to FIG. 3.

FIG. 8 is a view equivalent to FIG. 4.

FIG. 9 is a view which is equivalent to FIG. 1 and illustrates another embodiment in which an inverter and an oil tank are integrated with each other.

FIGS. 10(a) and 10(b) are explanatory views schematically illustrating the structure of the oil cooler in which FIG. 10(a) is a front view and FIG. 10(b) is a cross-sectional view viewed from the right side.

### EMBODIMENTS OF THE INVENTION

Hereinafter, embodiments of the present invention will be described with reference to the accompanying drawings. And throughout the following description, directions are used in reference to a vantage point of a driver of an electric motorcycle, seated on the driver's seat and facing forward.

### First Embodiment

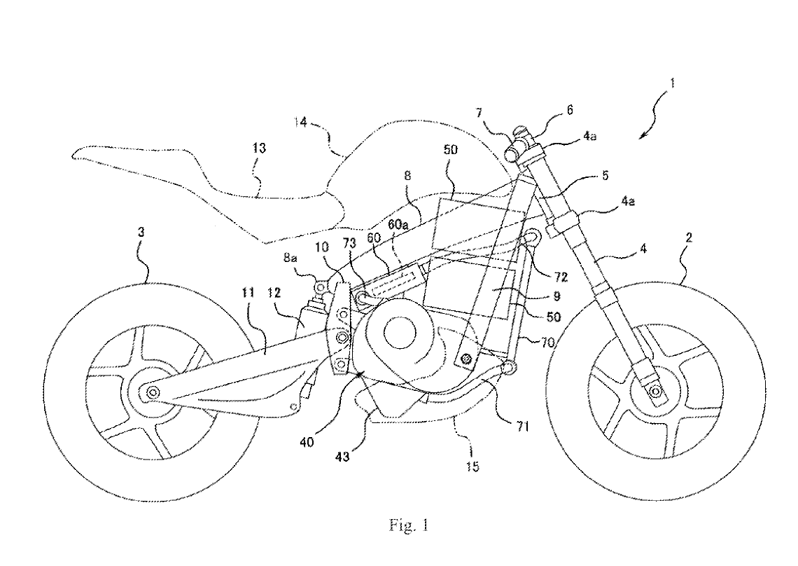

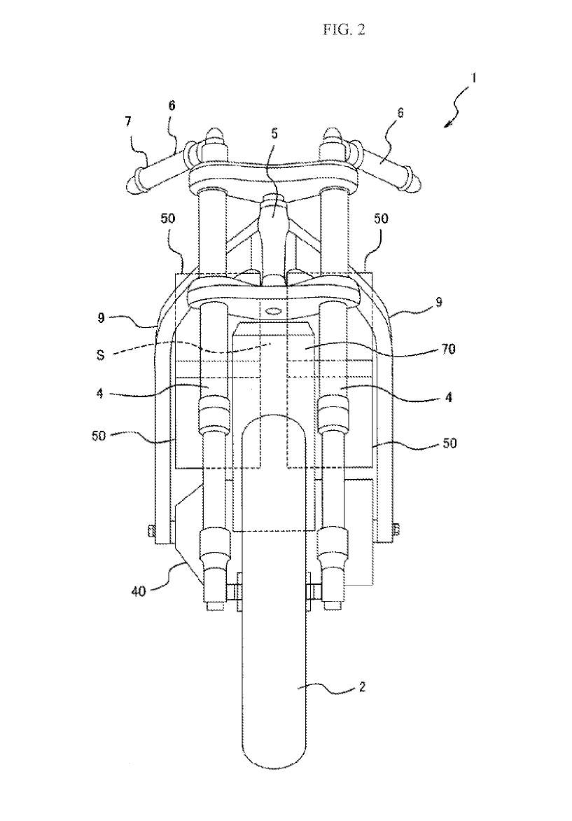

FIG. 1 is a right side view illustrating the main parts, such as a body frame, a power plant, and wheels, of an electric motorcycle 1 (electric vehicle) according to a first embodiment of the present invention, and FIG. 2 is a front view illustrating the same viewed from the front. As illustrated in FIG. 1, the electric motorcycle 1 includes a front wheel 2 as a steering wheel and a rear wheel 3 as a driving wheel. The front wheel 2 is freely rotatably supported by lower ends of a pair of left and right front forks 4 which almost vertically extend. On the one hand, upper portions of the front forks 4 are supported by a steering shaft (not illustrated) via upper and lower brackets 4a.

The steering shaft is freely rotatably supported in a state of being inserted in a head pipe 5 of the body, and constitutes a steering shaft. That is, a handle 6, which horizontally extends like a bar, is attached to the upper bracket 4a, and the driver can achieve steering by swinging the front fork 4 and the front wheel 2 on the steering shaft by using the handle 6. A right end of the handle 6 is gripped by the driver's right hand, and provided with an accelerator grip 7 which is rotatable by a twist of the driver's wrist.

The body frame of the electric motorcycle 1 includes, for example, a mainframe 8 which extends rearward and slightly inclines downward from the head pipe 5. This is constituted by a pipe member with a polygonal section which is, for example, an extrusion-molded product of an aluminum alloy, and a front end part of the mainframe is welded to the head pipe 5. Upper ends of a pair of left and right down frames 9 which extend downward are also welded to a position near the above-mentioned welding area, and these down frames 9 extend obliquely downward from the head pipe 5 while becoming horizontally farther from each other toward a lower side thereof until a horizontal distance between them reaches a predetermined value, and then further extend downward with a constant distance between them as illustrated in FIG. 2.

On the one hand, a portion of an upper frame part of a pivot frame 10 having, for example, a rectangular frame shape is welded to a rear end portion of the mainframe 8 such that the upper frame part horizontally extend in substantially perpendicular to a rear end portion of the mainframe 8. A rear portion of a case member of a power plant 40 described below in detail is fastened to the pivot frame 10, and a front portion of the case member is fastened to lower end portions of the down frames 9. That is, a lower portion of the body frame is constituted by the case member of the power plant 40 in the present embodiment.

A front end portion of a swing arm 11 which supports the rear wheel 3 is supported in a vertically rockable manner between a left frame part and a right frame part of the pivot frame 10, and the swing arm 11 extends rearward, slightly inclining downward, from a rocking pivot (pivot shaft). In the example illustrated in the drawing, a rear side portion of the swing arm 11 is bifurcated into two branches and the rear wheel 3 is supported between the two branches in a freely rotatable manner. On the one hand, a bulging portion which bulges downward is formed in a front portion of the swing arm 11, thereby supporting a lower end portion of a damper 12. An upper end portion of the damper 12 is supported on an extension 8a formed at the rear end portion of the mainframe 8, and the damper 12 expands and contracts with vertical locking of the swing arm 11.

As illustrated by an imaginary line in the drawing, a driver's seat 13 is disposed above the swing arm 11, and a dummy tank 14 is disposed ahead of the driver's seat 13. These are supported by a rear frame (not illustrated) which is connected to the mainframe 8. In the case of an electric motorcycle, a fuel tank is unnecessary, but the dummy tank 14 is useful because a driver, seating in a horse-riding posture, would insert it between his/her knees, inside of the dummy tank 14 is used as an accommodation such as a helmet. In addition, similarly, as illustrated by an imaginary line, an under guard 15 made of resin is disposed under the power plant 40.

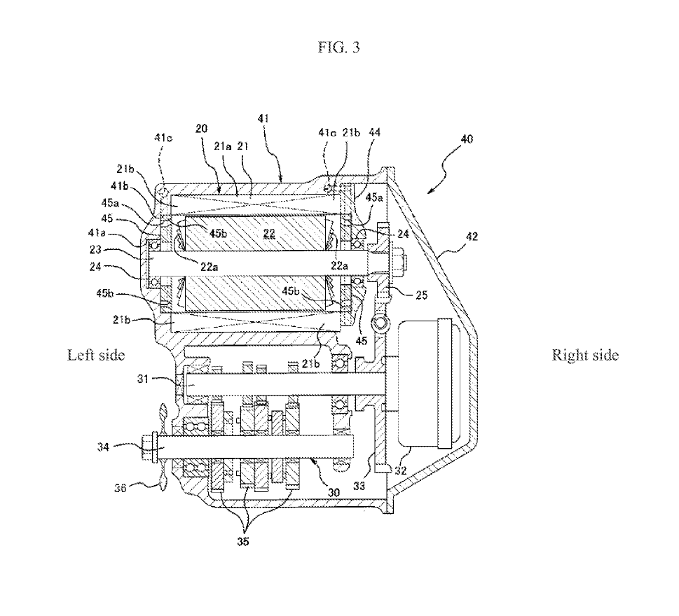

In a space, between the front wheel 2 and the rear wheel 3, in which an engine, a transmission, a throttle device, etc. are likely to be disposed if it is in the case of a conventional electric motorcycle, the power plant 40 equipped with a traveling motor 20 and/or a transmission device 30 (refer to FIG. 3), a battery 50 for supplying power to the traveling motor 20, and a power control controller 60 are disposed.

In the example illustrated in the drawing, the power plant 40 is connected from the lower end portion of the down frame 9 to the lower portion of the pivot frame 10. Within a space above it, four batteries 50 are disposed in a relatively front position and the power control controller 60 is disposed in a relatively rear position. For example, the four batteries 50 are symmetrically mounted, two on the left side of the mainframe 8 and two on the right side of the mainframe 8. As illustrated by a dashed line in FIG. 2, a vertically elongated space is formed between the left and right batteries 50. Although not illustrated, a power supply line extends from the batteries 50 to the power plant 40 via the power control controller 60.

Here, the traveling motor 20 is a motor/generator which performs a motor operation and a power generation operation, and drives the rear wheel 3 by performing the motor operation with the power supplied from the batteries 50 via the power control controller 60. The traveling motor 20 operates as a generator during regenerative braking of the electric motorcycle 1, so that the generated alternating current is converted into a direct current by an inverter of the power control controller 60 and the batteries 50 are charged. Control on the operation of the traveling motor 20 and/or charge-and-discharge control of the batteries 50 are mainly performed according to operation of the accelerator grip 7 and/or the traveling state of the electric motorcycle 1 as well known.

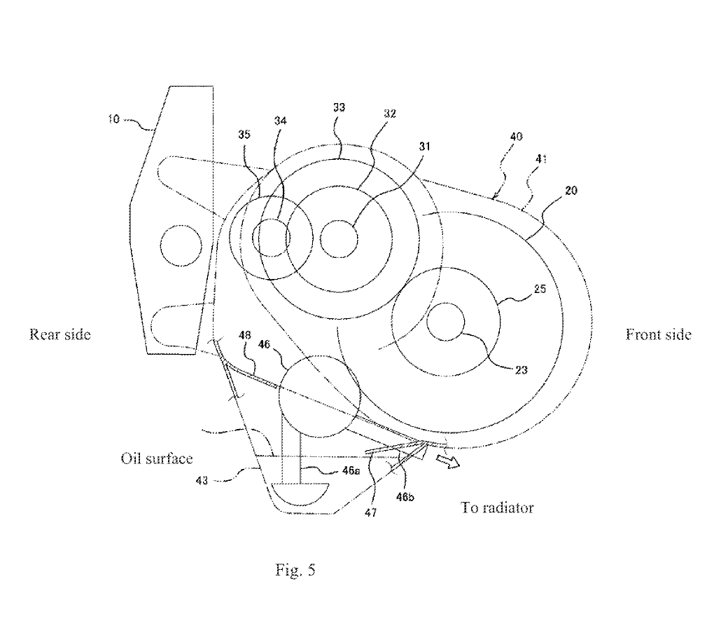

FIG. 3 illustrates the structure of the power plant 40 of the electric motorcycle 1. The case member of the power plant 40 which is illustrated is an elliptical barrel with a closed bottom when viewed from the side, and includes an outer case member 41 which is arranged such that the bottom is disposed on the left side, and a cap 42 which is fastened in a manner of overlapping and closing the opening on the opposite side (the right side). As illustrated by an imaginary line in FIG. 5, an oil pan 43 which is tapered at the bottom and bulges downward is provided underneath the outer case member 41.

Returning back to FIG. 3, the traveling motor 20 includes a stator 21 fixed to the outer case member 41, and a rotor 22 which rotates relative to the stator 21. In this example, the traveling motor 20 is formed by a so-called IPM motor in which a permanent magnet is embedded in an iron core of a rotor 22. Although not illustrated in detail, the stator 21 has a typical structure in which a plurality of magnet coils 21a is wound around an iron core (stator core) formed of an electromagnetic steel plate. The stator 21 is arranged such as to surround an outer circumference side of the rotor 22, and the outer circumference of the stator 21 is fixed to the outer case member 41.

On the one hand, a steel motor shaft 23 passes through the rotor 22, and both ends of the steel motor shaft 23 in a longitudinal direction are supported on the outer case member 41 via ball bearings 24, respectively. A left side ball bearing 24 is fitted in a circular recess portion 41a in the bottom of the outer case member 41, and a right side ball bearing 24 is disposed in a barrier wall part 44 of a different body fastened to the outer case member 41. The motor shaft 23 passes through the barrier wall portion 44, and protrudes from the right side of the barrier wall portion 44. A leading end portion of the motor shaft 23 is provided with an output gear 25.

As illustrated in even FIG. 5, a clutch shaft 31 as an input shaft of the transmission device 30 is disposed in the rear side of the traveling motor 20, a rotation output from the traveling motor 20 is switched so as to be input or intercepted by a multiplate clutch 32 disposed at a right end thereof. Namely, a clutch gear 33 is externally freely rotatably fitted near the right end of the clutch shaft 31, and meshes with an output gear 25 of the traveling motor 20. When this clutch gear 33 is connected to the clutch shaft 31 by the multiplate clutch 32, the clutch shaft 31 will come to rotate in conjunction with the motor shaft 23.

An output shaft 34 of the transmission device 30 is disposed in parallel with the clutch shaft 31, and is connected via a gear train 35 so as to be speed changeable. A speed change ratio of the input/output rotation, that is, a gear position of the transmission device 30 changes with a change in combination of the gears connected in the gear train 35. In this way, a sprocket 36 is provided in a left end of the output shaft 34 which outputs the gear-shifted rotation and, although not illustrated, a chain is wound it and a sprocket of the rear wheel 3.

—Structure for Cooling Traveling Motor, etc.—

In the present embodiment, in order to efficiently cool the traveling motor 20 and/or the inverter, non-conducting oil (coolant) is directly applied to a cooling fin provided in an inverter circuit board 60a and/or the magnet coil 21 a of the stator 21. Namely, as illustrated in FIG. 3, in the traveling motor 20, ejection holes 45b are provided in a bottom portion of the outer case member 41 facing an end surface on the left side of the rotor 22 and in the barrier wall portion 44 facing an end face on the right side of the rotor 22 such that the cooling oil can be ejected to be sprayed onto the coil end 21b of the stator 21.

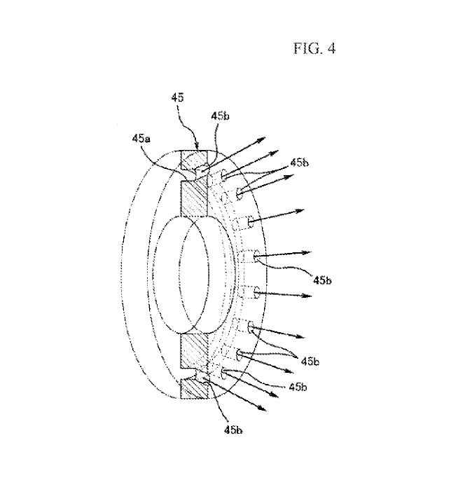

The ejection hole 45b illustrated on the left side in the drawing is described in detail. A relatively shallow large-diameter circular recess portion 41b continuous to the outer circumference of the recess portion 41a, into which a ball bearing 24 is fitted, is formed in the bottom portion of the outer case member 41. A disk-like member 45 (member in the case member side) having a round hole at the center is fitted in the recess portion 41b. In the disk-like member 45 which is schematically illustrated in FIG. 4, a ring-shaped groove 45a is formed to open at a position around the outer circumference of a rear surface, thereby forming a ring-shaped oil path when fitted into the recess portion 41b of the outer case member 41 as described above. This ring-shaped oil path communicates with an oil path 41c (a portion of which is illustrated in FIG. 3) which is formed in the outer case member 41, thereby receiving the supplied cooling oil as described below.

And a plurality of holes 45b extending from the ring-shaped groove 45a to the front surface of the disc-like member 45 is provided at substantially regular intervals in a circumferential direction of the ring-shaped groove 45a. These holes 45b are formed by cutting, for example, like drilled holes. In the example of the drawing, each of 18 holes 45b is obliquely formed to become gradually nearer the outer circumference side from a position communicating the ring-shaped groove 45a toward the front surface of the disc-like member 45. As indicated by an arrow in the drawing, the oil is radially obliquely ejected outward (hereinafter, the holes 45b are referred to as cooling oil ejection holes 45b or simply ejection holes 45b).

In this example, the ejection holes 45b are provided to correspond to the plurality of coils 21a wound around the core of the stator 21, and the oil ejected from the ejection holes 45b is sprayed positions corresponding to the plurality of coils 21a of the stator 21, respectively in the coil end 21b illustrated on the left side in FIG. 1. In the present embodiment, the disc-like member 45, into which the ring-shaped groove 45a, to serve as an ring-shaped oil path, and the plurality of ejection holes 45b communicating with the ring-shaped groove 45a are processed, is also assembled in the barrier wall portion 44 illustrated on the right side in the drawing like the same way as described above. In regards to the right side coil end 21b, the oil which is ejected from the ejection hole 45b is sprayed on positions corresponding to the plurality of coils 21a of the stator 21.

In this way, since the oil ejected from each of the plurality of ejection holes 45b is sprayed, the coil end 21b of the stator 21 which easily becomes a high temperature can be effectively cooled. Since the thermal conductivity of a coil in a winding direction is generally high, the cooling efficiency of the coil 21a disposed in a position corresponding to a cooling portion of the coil end 21b also improves. In addition, in regards to the holes 45b provided, the number of the holes in an upper portion of the disk-like member 45 may be larger than that in a lower portion of the disc-like member 45. With this configuration, more oil can be sprayed on the upper portion of the coil end 21b so that the whole coil can be efficiently cooled.

In the present embodiment, the traveling motor 20 is fixed to the outer case member 41 in the outer circumference of the stator 21 as illustrated, and the outer circumference side of the stator 21 radiates heat to the air via the outer case member 41. However, it can be said that the heat easily accumulates inside the inner circumference. Therefore, the oil ejection hole 45b is provided so as to face the end surface of the rotor 22 which is disposed on the inner circumference side, and is configured to spray the oil onto the inner circumference of the coil end 21b of the stator 21, which is disposed on the outer circumference side.

In this way, by appropriately setting the orientation of the oil ejection holes 45b so as to aim at the coil end 21b on the outer circumference side, the oil can be sprayed onto the coil end 21b as intended, and there is a little risk that the ejected oil enters into the gap between the stator 21 and the rotor 22. In addition, since the ejection pressure of the oil is adjusted to fall within in a suitable range by control of the oil pump 46 described below, the oil rebounding from the coil end 21b can be suppressed and there is a little risk that the oil, which rebounded, enters into the gap between the stator and the rotor.

In addition, in the example of the drawing, the fin 22a is provided in the end surface of the rotor 22 so that air may be sent outward in the rotary shaft direction (toward the right side if it is disposed on the right end surface, and toward the left side if it is disposed on the left end surface) along with the rotation. Since the wind which is created in this way will blow away the oil which drops from the coil end 21b from above so that the oil moves away from the rotor 22, the invasion of the oil into the gap between the rotor 22 and the stator 21 is prevented.

As described above, the oil which was sprayed to the coil end 21b and deprived the coil end 21b of almost all of the heat flows downward along the windings extending in a circumferential direction of the coil end 21b, and drops downward from the lower end portion of the coil end 21b, reaching the oil pan 43. Since the amount of oil stored in the oil pan 43 as illustrated in FIG. 5 is set up such that the oil surface is lower than the lowest portion of the stator 21, the windings of the coil 21a are not likely to remain immersed in the oil. Accordingly, this configuration is advantageous in suppressing the degradation f the covering.

Furthermore, in the present embodiment, since baffle plates 47 and 48 (partition plates between the oil surface of the oil and the lowest portion of the stator 21 disposed above the oil surface) are provided on the front side and the rear side of the oil pump 46, respectively, there is also no risk of the stored oil rising along the wall surface of the oil pan 43 and reaching the traveling motor 20 at the time of the acceleration-and-deceleration of the electric motorcycle 1. Yet furthermore, since the baffle plate 47 provided in front of the oil pump 46 is disposed to incline downward toward the rear side and the baffle plate 47 disposed behind the oil pump 46 is disposed to incline downward toward the front side, the oil which falls from above is smoothly guided into the oil pan 46.

Then, the oil which comes to be stored in the oil pan 43 is pumped up by the electric oil pump 46 and fed to an oil cooler 70. The oil pump 46 is driven by an electric motor, for example, thereby taking in the oil from a strainer 46a and discharging the oil from a discharge port 46b. In this example, the discharge port 46b extends through the outer case member 41, and is equipped with an upstream end of a lower hose 71. As illustrated in FIG. 1, the lower hose 71 passes through a lower portion of the power plant 40, extends up to the front portion thereof, and is connected to a lower portion of the oil cooler 70 (heat exchanger) disposed in front of the batteries 50.

The oil cooler 70 is disposed a little ahead of the down frame 9, by and large, ranging from a position under the front end portion of the mainframe 8 to the lower end of the down frame 9. When the electric motorcycle 1 is viewed from the front as illustrated in FIG. 2, the oil cooler 70 extends to be longer in the vertical direction and to be interposed between left and right front forks 4, and a vertically long space S is provided between left and right batteries 50 disposed behind the oil cooler 70 as illustrated by a dashed line. Since the space S functions as a passage way for a traveling wind which passes by the oil cooler 70, not only the traveling wind is smoothly introduced to the oil cooler 70 but also the traveling wind smoothly escapes through the vertically long space S. Accordingly, cooling efficiency may improve. Furthermore, the traveling wind also contributes to cooling of the batteries 50.

In addition, the oil which is fed from the oil pump 46 to the lower portion of the oil cooler 70 as described above is cooled by heat-exchanging with the traveling wind while it is rising through the fluid path in the core of the oil cooler 70. The oil which is cooled in this way is introduced into an upper hose 72 connected to the upper portion of the oil cooler 70. In the example of the drawing, the upper hose 72 makes the space between the left and right batteries 50 extend rearward, and a downstream end of the upper hose 72 is connected to the power control controller 60.

In the present embodiment, a case member of the power control controller 60 has a flat rectangular box shape, and is disposed to incline downward toward the rear side, on the rear side of the space disposed above the power plant 40. The upper hose 72 is connected to the front side of the case member. As illustrated by a dashed line in the drawing, a circuit board 60a of an inverter is accommodated in the case member and the fluid path for the oil is formed such that the cooling fin joined to the circuit board may be immersed. The oil which flows through the fluid path effectively cools the circuit board 60a.

A middle hose 73 for returning the oil to the power plant 40 is connected to the rear side of the case member of the power control controller 60. The oil which is circulated in the inside of the middle hose 73 flows into the oil path 41c in the outer case member 41 from an oil inflow port provided in an upper portion of the outer case member 41 of the power plant 40. Thus, the oil which is circulated in the inside of the oil path 41c is ejected from the ejection hole 45b as described above, and is sprayed onto the coil end 21b of the stator 21 of the traveling motor 20.

That is, a circulation fluid path which circulates the oil among the power plant 40, the power control controller 60, and the oil cooler 70 is constituted by the lower hose 71, the upper hose 72, and the middle hose 73. The oil cooled by the oil cooler 70 is first supplied to the power control controller 60 and is then supplied to the power plant 40 because an operation temperature of the traveling motor 20 is higher than an operation temperature of the inverter 60a.

Although not illustrated in the drawing, the oil path 41c in the outer case member 41 is configured such that the oil may be supplied also to the ball bearing 24 which supports a motor shaft 23 of the traveling motor 20, a bearing of the clutch shaft 31, the output shaft 34, etc. of the transmission device 30, and/or the gear train 35. The oil is supplied to lubricate and cool them.

Operation speed of the oil pump 46 which feeds and circulates the oil in the way described above can be changed by control of the electric motor which drives it. For example, the operation speed and a discharge amount of the oil increase according to a current value supplied to traveling motor 20 from an inverter, that is, with an increase in the current. When the control is performed like this, the ejection pressure of the oil ejected from the ejection hole 45b also becomes higher. However, the ejection pressure is excessively high, the amount of oil rebounding from the coil end 21b increases. Accordingly, the operation speed of the oil pump 46 is suppressed to be a predetermined value or below.

The operation control of the oil pump 46 may be performed by the power control controller 60, for example. That is, the power control controller 60 functions also as control means of the oil pump 60 which monitors a supply current from the inverter 60a and controls the current value supplied to the electric motor of the oil pump 46 according to the supply current from the inverter 60a.

As described above, in the electric motorcycle 1 according to the present embodiment as described above, the oil is directly sprayed especially to the coil end 216 of the stator 21 which easily becomes a high temperature in the traveling motor 20 of the power plant 40, thereby effectively depriving the electric motor of the heat. Furthermore, the oil which has risen in temperature after being sprayed is circulated between the temperature-increased position and the oil cooler 70 so that the oil exchanges the heat with the traveling wind. With this configuration, even with a simple structure, a very high cooling effect of the motor is acquired.

In addition, a sufficient amount of oil can be supplied to the coil end 21b as intended and the rebounding of the oil from the coil end 21b can be suppressed by adjusting the ejection amount and the ejection pressure of the oil ejected from the oil ejection hole 45b by operation control of the oil pump 46. Therefore, there is a little risk that the oil enters into the gap between the stator 21 and the rotor 22 and the rotation resistance rapidly increases.

In addition, before supplying the oil from the oil cooler 70 to the traveling motor 20, the oil is introduced into the case member of the power control controller 70 so as to be brought into direct contact with the circuit board 60a of the inverter stored there, and the cooling of the inverter is very effectively performed.

Thus, since the oil which is circulated through the power plant 40, the power control controller 60 and the oil cooler 70 deprives of the heat by direct contact with the stator 21 and/or the inverter 60a as described above, and other coolants such as LLC and the like need not to be used, troubles such as an increase in size or weight, a cost hike, and complicated maintenance hardly occur.

### Second Embodiment

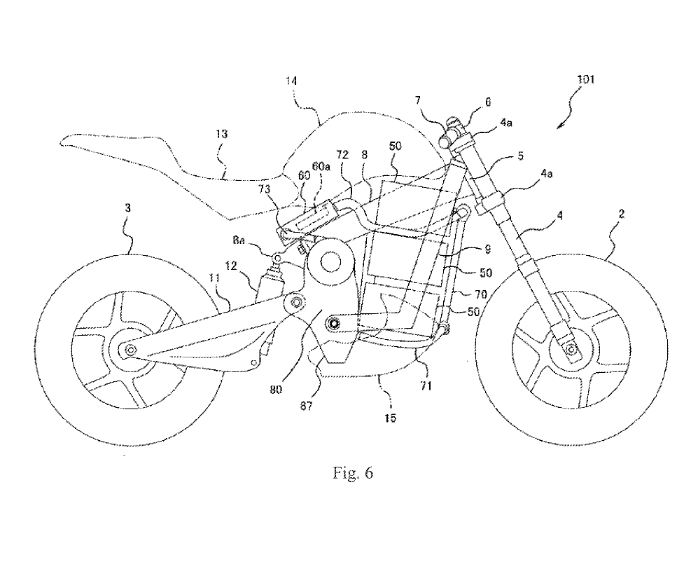

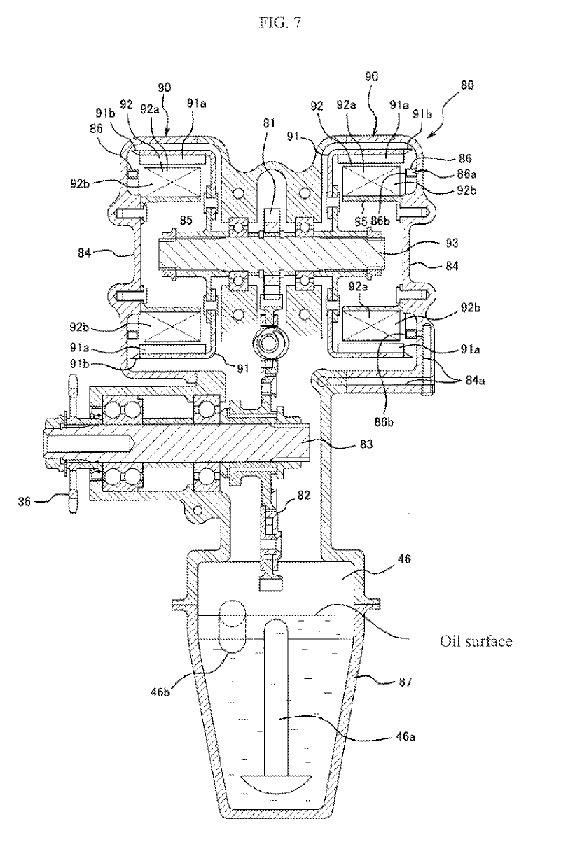

FIGS. 6 and 7 illustrate an electric motorcycle 101 according to a second embodiment of the present invention. Both figures are equivalent to FIGS. 1 and 3 according to the first embodiment, respectively. Although an electric motorcycle 101 of the second embodiment mainly differs in the structure of a power plant from the first embodiment and hence differs also in the mounting positions of batteries 50 and a power control controller 60, there are no other differences in the other basic structure. Accordingly, equivalent members are denoted by identical reference signs and a description thereof is omitted.

A power plant 80 of the second embodiment does not include a transmission device 30 so that the power plant 80 is very compact in a forward and rearward direction as illustrated in FIG. 6. For this reason, as illustrated in the drawing, down frames 9 extend rearward from a lower end, and a case member of the power plant 80 is fastened to a rear end. In addition, a pivot frame 10 is removed so that a rocking pivot (pivot shaft) of a swing arm 11 is provided in the case member of the power plant 80 and an upper end of the case member is fastened to a rear end portion of a mainframe 8.

In addition, since there is a margin in a front space of the power plant 80, in the example of the drawing, six batteries 50 can be mounted, three on the left side and three on the right side, and this margin is advantageous in increasing a traveling distance of the electric motorcycle 101. On the one hand, since the power plant 80 is slightly longer in a vertical direction, the power control controller 60 is moved to above the mainframe 8, and management of an upper hose 72 and a middle hose 73 is changed in conjunction with this. The upper hose 72 passes between the left and right batteries 50, and then passes through the right side of the mainframe 8, thereby extending up to the power control controller 60. The middle hose 73 may be provided to also pass through the right side of the mainframe 8.

As illustrated in FIG. 7, a traveling motor 90 of the power plant 80 is configured such that a permanent magnet 91 a is not embedded in but attached to a rotor 91, and the traveling motor 90 is generally called an SPM motor. In the example of the drawing, two traveling motors, which have conventionally used as a generator of a motorcycle and the like, are used, sharing a motor shaft 93. A driving gear 81 is installed at a center of the motor shaft 93, and a driven gear 82 which meshes with the driving gear 81 is provided at an end portion of an output shaft 83 of the power plant 80.

That is, in the example of the drawing, the power plant 80 does not include a transmission device 30 unlike the first embodiment, and rotation of the motor shaft 93 is slowed down according to a gear ratio of the driving gear 81 and the driven gear 82, and is then transmitted to the output shaft 83.

In addition, arrangement in the traveling motor 90 is in reverse to that of the first embodiment. That is, a stator 92 is located in an inner circumference side and a rotor 91 is arranged to surround an outer circumference of the stator 92. For example, the traveling motor 90 illustrated on the right side in FIG. 7 will be described. The rotor 91 is a flat bottomed cylindrical shape having an opening on the right side. The motor shaft 93 passes through a center of the bottom disposed on the left side. The motor shaft 93 and the bottom of the rotor 91 are spline-fitted.

A plurality of permanent magnets 91a having a thin plate shape is arranged in a circumference direction in an inner circumferential surface of a circumferential wall of the rotor 91, and an iron core (core) of the stator 92 is arranged near the inner circumference side. A predetermined gap is formed between an outer circumferential surface of the stator and an inner circumferential surface of the permanent magnet 91a of the rotor 91.

The stator 92 is attached, via a circular cylindrical support member 85, to a case member 84 which constitutes a portion of the case member of the power plant 80, and an ejection hole 86b for cooling oil is provided in the case member 84 which faces in proximity to the right end. That is, a circular ring-shaped member 86 is attached to the case member 84, thereby forming a circular ring-shaped oil path 86a. The oil path 84a in the case member 84 communicates with this oil path 86a, so that the cooling oil is supplied.

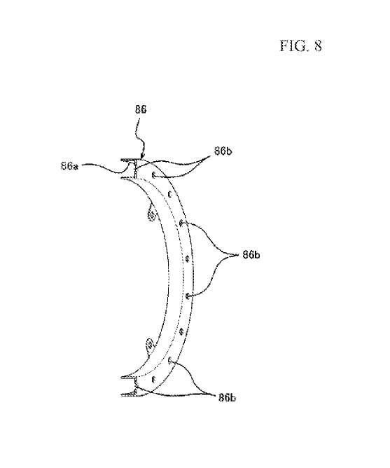

As illustrated in an expanded manner in FIG. 8, the circular ring-shaped member 86 has a C-shaped section, and a circular ring-shaped groove in the inside thereof serves as the oil path 86a. And a plurality of holes (ejection holes 86b) is provided in the circular ring-shaped member 86 at almost regular intervals in a circumference direction such as to communicate with the ring-shaped oil path 86a, and each hole is formed in a manner of ejecting the cooling oil toward a coil end 92b of the stator 92.

Although the details are not illustrated, the plurality of ejection holes 86b are provided so as to correspond to a plurality of magnet coils 92a wound around the core of the stator 92, respectively like the first embodiment, and the oil ejected from each ejection hole 86b is sprayed to a position corresponding to the magnet coil 92a in the coil end 92b on the right side in the drawing. With this configuration, the coil end 92b of the stator 92 and furthermore the coils 92a can be effectively cooled.

In addition, the ejection holes 86b may also be provided such that the number of the ejection holes 86b disposed in an upper portion of the circular ring-shaped member 86 is larger than that in a lower portion of the circular ring-shaped member 86. With this configuration, a larger amount of oil can be sprayed onto an upper portion of the coil end 92b, so that the whole can be efficiently cooled.

In this way, a portion of the oil which has deprived the coil end 92b of the heat flows downward from a support member 85 of the stator 92 via an inner surface of the case member 84, and reaches an oil pan 87 located under the case member. In addition, a portion of the oil flows downward along windings of the coil end 92b, and drops downward from a lower end to the oil pan 87. In this way, a portion of the oil which falls down is brought into contact with the rotor 91 but is sprayed by a centrifugal three of the rotor 91 which rotates at high speed. Therefore, there is a little risk of invasion of the oil into the gap between the rotor and the stator 92.

Furthermore, in the example of the drawing, since a fin 91b is provided in an end portion of the rotor 91, a wind traveling away from the rotor 91 is created due to the rotation. Accordingly, the oil is sprayed away by the wind. In the example of the drawing, an oil surface of the oil stored in the oil pan 87 is set to a position lower than a lowest portion of the driven gear 82 so that agitating resistance may not be generated.

In addition, although not illustrated, the rotor 91 is reduced in size in a rotary shaft direction, and a right end is moved to the left side. However, a portion which protrudes outward from a right end surface of the rotor 91 may be provided near a lower end portion of coil end 92b of the stator 92. With this configuration, the oil which falls from the lower end portion of the coil end 92b hardly reaches the rotor 91. Accordingly, this configuration is advantageous in preventing invasion of the oil into the gap between the rotator and the stator 92.

### Other Embodiment

The embodiments in the above description are just only examples, and do not limit the present invention, its applications, and its use. For example, in the first embodiment, ejection holes 45b for cooling oil are provided on left and right sides of a rotor 22 of a traveling motor 20, respectively, and oil is sprayed onto coil ends 21a on both left and right sides of a stator 21. However, the present invention is not limited to this. For example, the oil may be sprayed onto only either one coil end like in the second embodiment.

Although the oil pump 46 for feeding cooling oil is accommodated in the case member of the power plant 40 or 80 to pump out the oil stored in the oil pan 46 or 87 in the above-described embodiments, the present invention is not limited thereto. That is, the oil pump 46 may be disposed near an oil cooler 70.

Conversely, when it is accommodated in the case member of the power plant 40 or 80, a mechanical pump may be connected so as to be driven by a motor shaft 23 or 92 of a traveling motor 20 or 90. When configured in this way, since a discharge amount of the oil from the pump increases as rotation speed of the traveling motor 20 or 90 increases, as a result, cooling adaptively performed according to a temperature state of the traveling motor 20 or 90 can be achieved.

Although cooling oil is sent out from the inside of the case member of the power plant 40 or 80 and is circulated between the case member and the oil cooler 70 through which the traveling wind passes in the above-described embodiments, the present invention is not limited thereto. The oil may be circulated within the case member and the case member may be cooled by air or another cooling water.

Although both of the traveling motor 20 or 90 and the power control controller 60 are cooled by oil in the above-described embodiments, only either one may be cooled. For example, in regards to the power control controller 60, the cooling fin joined to the circuit board 60a of the inverter is not immersed in the oil but the circuit board 60a may be cooled via a cooler in which oil flows.

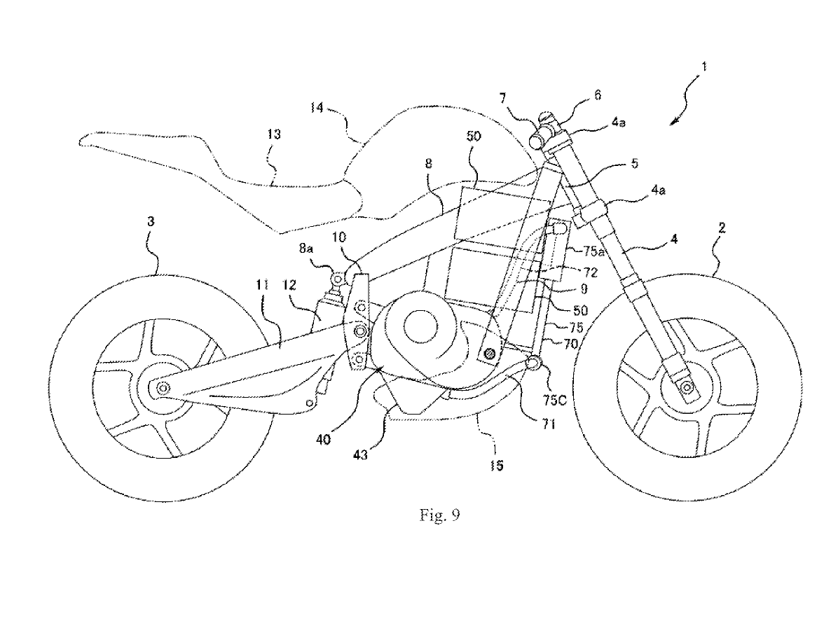

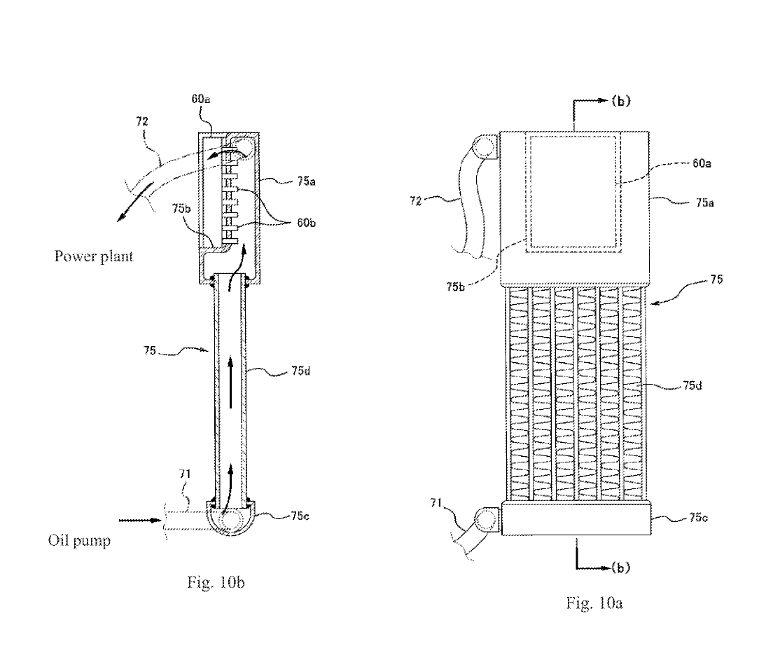

The circuit board 60a of the inverter may be integrally formed with the oil cooler. For example, as illustrated in FIGS. 9 and 10, the oil cooler 75 has a recess portion 75b which is open at a rear side so that an upper tank 75a thereof may be formed in a large size as compared with the first embodiment, and have a flat U shape when viewed from above. And the circuit board 60a of the inverter may be installed to be fitted into the recess portion 75b. The cooling fin 60b is joined to a front surface of the circuit board 60a like the first embodiment, and this passes through a wall surface of the recess portion 75b of the upper tank 75a and is immersed in the oil in the tank.

According to this configuration, the oil which is fed from the oil pump 46 of the power plant 40 and introduced into the lower tank 75c of the oil cooler 75 is cooled by heat exchange with the traveling wind while it is rising through the fluid path in the core 75d of the oil cooler 75. Thus, the oil effectively cools the circuit board 60a of the inverter in the upper tank 75a of the oil cooler 75, and then flows into the upper hose 72 connected to the upper tank 75a.

Although a description is made about the electric motorcycle 1 in each of the above embodiments, the electric vehicle according to the present invention is not limited to the motorcycle, and for example, it may be an ATV (All Terrain Vehicle), a mechanical mule, and the like.

### INDUSTRIAL APPLICABILITY

As described above, since the cooling structure for cooling an electric vehicle according to the present invention can obtain an increased cooling efficiency compared with a conventional art, and has a simple structure which hardly increases size and weight and/or causes a cost hike, it is especially useful for an electric motorcycle.

### DESCRIPTION OF REFERENCE SIGNS

1: Electric motorcycle (vehicle)

2: Front wheel

20, 90: Traveling motor (electric motor for traveling)

21, 92: Stator

21a, 92a: Magnetic coil

21b, 92b: Coil end

22, 91: Rotor

22a, 91b: Fin

30, 81, 82: Transmission device (gear type driving force transmission mechanism)

40, 80: Power plant

41: Outer case member (case member of an electric motor)

41c, 84a: Fluid path communicating with ejection hole

45: Disk-like member (member of case member side)

45b, 86b: Ejection hole for cooling oil

46: Electric pump (cooling liquid feeding means)

60: Power control controller (control means)

70: Oil cooler (heat exchanger)

71: Lower hose (circulation fluid path)

72: Upper hose (circulation fluid path)

73: Middle hose (circulation fluid path)

1. A cooling structure for an electric motor in a vehicle, the electric motor including a stator fixed to a case and a rotor rotating relative to the stator, the cooling structure comprising:
an ejection hole provided in a member of the case, the member facing an end surface of the rotor in a rotary axis direction of the rotor; and
a coolant feeder that feeds a coolant to a fluid path communicating with an ejection hole for ejecting a coolant,
wherein the coolant ejected from the ejection hole is made to be sprayed to at least a coil end of the stator.

2. The cooling structure according to claim 1, wherein the ejection hole is provided plural in number so that the ejection holes spray coolants to a plurality of coils of the stator, respectively.

3. The cooling structure according to claim 1, wherein a rotary axis of the rotor substantially horizontally extends, and
the plurality of ejection holes for the coolant is provided such that the ejection holes disposed above the rotary axis of the rotor are larger in number than the ejection holes disposed below the rotary axis of the rotor.

4. The cooling structure according to claim 1, wherein the stator is fixed to the case and arranged to surround an outer circumference side of the rotor, and
the ejection holes for the coolant are provided in an inner circumference side which is located inner than a coil end of the stator.

5. The cooling structure according to claim 1, wherein at least a portion of a fluid path communicating with the ejection hole is formed between a plurality of members of the case which overlap each other, and the ejection hole is formed in at least one of the members of the case.

6. The cooling structure according to claim 5, wherein an ejection direction of the ejection hole is set to be oriented to the coil end.

7. The cooling structure according to claim 1, wherein a heat exchanger is disposed outside the case of the electric motor such that a traveling wind passes by, and
a circulation fluid path, allowing the coolant in the case to circulate between the inside of the case and the heat exchanger, is provided.

8. The cooling structure according to claim 1, wherein the coolant feeder includes an electric pump that is variable in operation speed.

9. The cooling structure according to claim 8, further comprising a controller that controls the electric pump according to at least an operation state of the electric motor.

10. The cooling structure according to claim 1, wherein the coolant feeder includes a mechanical pump mechanically connected to the electric motor.

11. The cooling structure according to claim 1, wherein besides the stator and the rotor, a gear type driving force transmission mechanism transmitting a torque of the electric motor is also accommodated in the case, and the coolant is used for lubricating the driving force transmission mechanism.

12. The cooling structure according to claim 1, wherein a storage part for a coolant is provided in a lower portion of the case and a lowest portion of the stator is located above a liquid surface of the coolant.

13. The cooling structure according to claim 1, wherein a storage part for a coolant is provided in a lower portion of the case and a partition plate is provided between a liquid surface of the coolant in the storage part and the lowest portion of the stator which is disposed above the liquid surface.

14. The cooling structure according to claim 1, wherein a fin is provided in the end surface of the rotor in the rotary axis direction so that air blows outward in the rotary axis direction due to rotations of the rotor.
